(19) United States
(12) Patent Application Publication
(10) Pub. No.: US 2018/0253064 A1
(43) Pub. Date: Sep. 6, 2018

(54) ARM-WORN DISPLAY DEVICE, DISPLAY METHOD, AND COMPUTER-READABLE RECORDING MEDIUM

(71) Applicant: NEC CORPORATION, Tokyo (JP)

(72) Inventor: Hideo HASEGAWA, Tokyo (JP)

(73) Assignee: NEC CORPORATION, Tokyo (JP)

(21) Appl. No.: 15/760,295

(22) PCT Filed: Sep. 15, 2016
(86) PCT No.: PCT/JP2016/077259

§ 371 Date: Mar. 15, 2018

(30) Foreign Application Priority Data
Sep. 24, 2015 (JP) 2015-186385

(51) Int. Cl. G04G 9/00; G06F 1/16; G06F 3/0484; G06F 3/0487; G09G 5/36; G04G 21/00

(52) U.S. Cl. CPC G04G 9/0064; G06F 1/163; G04G 21/00; G06F 3/0487; G09G 5/36; G06F 3/0484

(57) ABSTRACT

Provided is an arm-worn display device that is configured such that information displayed on the display can be easily visually recognized no matter whether the arm-worn display device is worn on the right or left arm. The arm-worn display device 1 includes a band unit 11 configured to be worn on an arm, a display unit 12 configured to display character information in such a manner that an upward/downward direction of the character information coincides with a width direction of the band unit 11 and the character information is aligned in a longitudinal direction of the band unit 11, an attachment detection unit 13 configured to detect attachment of the band unit 11 to an arm, a direction detection unit 14 configured to detect at least one of an upward direction and a downward direction of the display unit 12 when the attachment detection unit 13 has detected the attachment of the band unit 11 to an arm, and a display control unit 15 configured to set a display orientation of the display unit 12 on the basis of a detection result of the direction detection unit 13.

### TECHNICAL FIELD

The present invention relates to arm-worn display devices that are worn on an arm, display methods for the arm-worn display devices, and computer-readable recording media storing programs for carrying out the arm-worn display devices and the display methods.

### BACKGROUND ART

In recent years, many arm-worn display devices that are worn on an arm and can display various items of information have become widespread. Such arm-worn display devices have a wristband-shaped housing and a display, as disclosed in Patent Document 1, for example. This allows a user to easily visually recognize information displayed on the display.

The arm-worn display device disclosed in Patent Document 1 above is configured such that the display extends relative to the wristband-shaped housing in the circumferential direction of the housing. As a result, the display displays information, such as characters, etc., in such a manner that the information is aligned in the circumferential direction of the housing.

Note that, in the configuration disclosed in Patent Document 1, the display displays information in such a manner that the upward direction of the information coincides with one of the opposite directions along the width direction of the housing.

### LIST OF PRIOR ART DOCUMENTS

### Patent Document

Patent Document 1: JP 2015-515287A

### DISCLOSURE OF THE INVENTION

### Problems to be Solved by the Invention

Incidentally, arm-worn display devices having a configuration similar to that which is disclosed in Patent Document 1 are generally often worn on the non-dominant arm of a user. A wristband with a key for a locker provided in a facility, such as a gym, etc., a wristwatch, etc., are also often worn on the non-dominant arm of a user. Thus, when a user wears a wearable object on his or her arm, the arm is highly likely to be the non-dominant arm of the user.

Therefore, for example, when a user tries to wear a wristband with a key for a locker in a gym, etc., or the like, on his or her arm in a state where the user is wearing an arm-worn display device on his or her non-dominant arm, the user is likely to switch the arm-worn display device from the non-dominant arm to the dominant arm, and wear the wristband, which is relatively difficult to wear, on the non-dominant arm.

In a state where a user wears both a wristwatch and an arm-worn display device in everyday life, the user wears the wristwatch on the non-dominant arm, and the arm-worn display device on the dominant arm. When the user has taken off his/her wristwatch for playing sports, the user is likely to wear the arm-worn display device on the non-dominant arm so that the motion of the dominant arm is not hampered by the arm-worn display device.

Thus, a user is likely to switch an arm-worn display device between the right and left arms, depending on the state.

However, in the case of arm-worn display devices having a configuration similar to that which is disclosed in Patent Document 1, when the display (display unit) is viewed in the other of the positive and negative width directions of the band unit, information is displayed upside down. Therefore, in the case that an arm-worn display device is switched between the right and left arms, there is the possibility that when the arm-worn display device is worn on one arm, information displayed on the display cannot be visually recognized.

It is an object of the present invention to provide an arm-worn display device that is configured such that information displayed on the display can be easily visually recognized no matter whether the arm-worn display device is worn on the right or left arm.

### Means for Solving the Problems

To achieve the object, an arm-worn display device according to an aspect of the present invention includes a band unit configured to be worn on an arm, a display unit configured to display character information in such a manner that an upward/downward direction of the character information coincides with a width direction of the band unit and the character information is aligned in a longitudinal direction of the band unit, an attachment detection unit configured to detect attachment of the band unit to an arm, a direction detection unit configured to detect at least one of an upward direction and a downward direction of the display unit when the attachment detection unit has detected the attachment of the band unit to an arm, and a display control unit configured to set a display orientation of the display unit on the basis of a detection result of the direction detection unit.

To achieve the object, a display method according to an aspect of the present invention is for an arm-worn display device including a band unit configured to be worn on an arm, and a display unit configured to display character information in such a manner that an upward/downward direction of the character information coincides with a width direction of the band unit and the character information is aligned in a longitudinal direction of the band unit. The method includes an attachment detection step of detecting attachment of the band unit to an arm, a direction detection step of detecting at least one of an upward direction and a downward direction of the display unit when the attachment of the band unit to an arm is detected in the attachment detection step, and a display setting step of setting a display orientation of the display unit on the basis of a detection result of the direction detection step.

To achieve the object, a computer-readable recording medium according to an aspect of the present invention stores a program for controlling displaying on an arm-worn display device including a band unit configured to be worn on an arm, a display unit configured to display character information in such a manner that an upward/downward direction of the character information coincides with a width direction of the band unit and the character information is aligned in a longitudinal direction of the band unit, and a computer. The medium contains instructions for causing the computer to execute an attachment detection step of detecting attachment of the band unit to an arm, a direction detection step of detecting at least one of an upward direction and a downward direction of the display unit when the attachment of the band unit to an arm is detected in the attachment detection step, and a display setting step of setting a display orientation of the display unit on the basis of a detection result of the direction detection step.

### ADVANTAGEOUS EFFECTS OF THE INVENTION

Thus, according to the features of the present invention, provided is an arm-worn display device that is configured such that information displayed on the display can be easily visually recognized no matter whether the arm-worn display device is worn on the right or left arm.

### BRIEF DESCRIPTION OF THE DRAWINGS

FIG. 1 A block diagram schematically showing a configuration of an arm-worn display device.

FIG. 2 A perspective view showing an arm-worn display device.

FIG. 3A A diagram showing an example in which an arm-worn display device is worn on the left arm.

FIG. 3B A diagram showing an example in which an arm-worn display device is worn on the right arm.

FIG. 4 A block diagram showing an overall configuration of an arm-worn display device.

FIG. 5 A flowchart showing an operation of setting a display orientation of a display unit of an arm-worn display device.

FIG. 6 A diagram showing an example configuration of a computer.

### MODE FOR CARRYING OUT THE INVENTION

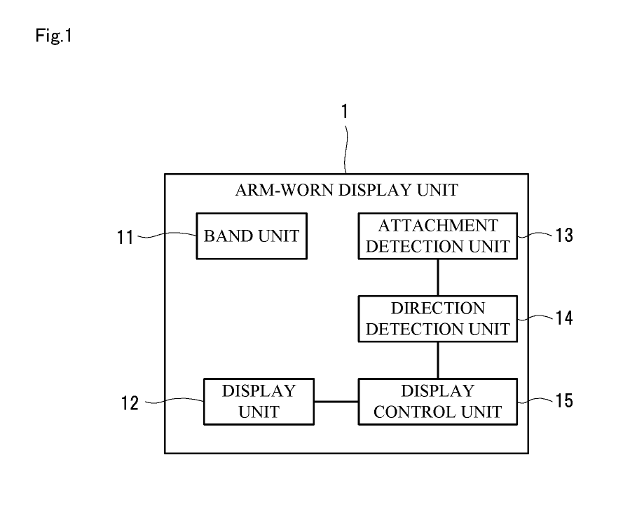

An arm-worn display device, display method, and program according to an embodiment of the present invention will now be described with reference to FIGS. 1-6.

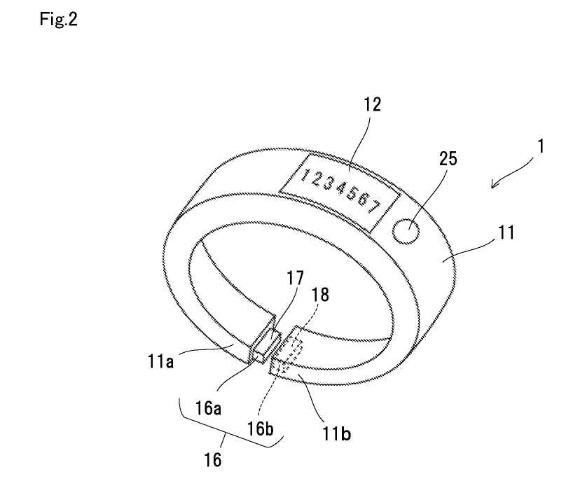

FIG. 1 is a block diagram showing an overall configuration of an arm-worn display device 1 according to an embodiment of the present invention. FIG. 2 is a perspective view schematically showing a configuration of the arm-worn display device 1. The arm-worn display device 1, which is worn on an arm, can display information, such as time, the amount of activity, heartbeat, etc.

The arm-worn display device 1 includes a band unit 11, a display unit 12, an attachment detection unit 13, a direction detection unit 14, and a display control unit 15.

The band unit 11, which is formed in the shape of a band, includes end portions 11a and 11b that are configured to connect to each other so that the band unit 11 can be worn on a user's arm. In other words, the band unit 11 is in the shape of a circular ring when worn on an arm. The band unit 11 is made of a flexible material, such as a resin material, etc.

The display unit 12 includes, for example, a liquid crystal display device, an LED display device including a plurality of LEDs, etc. The display unit 12 is provided on an outer peripheral surface and in a middle portion in the longitudinal direction of the band unit 11 that is in the shape of a circular ring when worn on an arm. The display unit 12 displays information containing character information in such a manner that the upward/downward direction of the information coincides with the width direction of the band unit 11 and the information is aligned in the longitudinal direction of the band unit 11.

As a result, when the band unit 11 is worn on an arm, the user can visually recognize information displayed on the display unit 12, with the upward/downward direction of the information coinciding with the width direction of the band unit 11.

The attachment detection unit 13 detects attachment of the band unit 11 to an arm. Specifically, the attachment detection unit 13 detects connection between the end portions 11a and 11b of the band unit 11 at the time when the band unit 11 is attached to an arm. For example, the connection between the end portions 11a and 11b of the band unit 11 is detected on the basis of contact between terminals provided on the end portions 11a and 11b.

When the attachment detection unit 13 has detected the attachment of the band unit 11 to an arm, the direction detection unit 14 detects at least one of the upward and downward directions of the display unit 12. Specifically, at the time when the band unit 11 is attached to an arm, the direction detection unit 14 detects the upward/downward direction of the display unit 12 using, for example, a gravity sensor, etc.

The display control unit 15 sets the display orientation of the display unit 12 on the basis of the detection result of the direction detection unit 14. Specifically, the display control unit 15 sets the display orientation of information displayed on the display unit 12 according to the upward/downward direction of the display unit 12 detected by the direction detection unit 14 such that the display orientation of the display unit 12 is suited to the upward/downward direction.

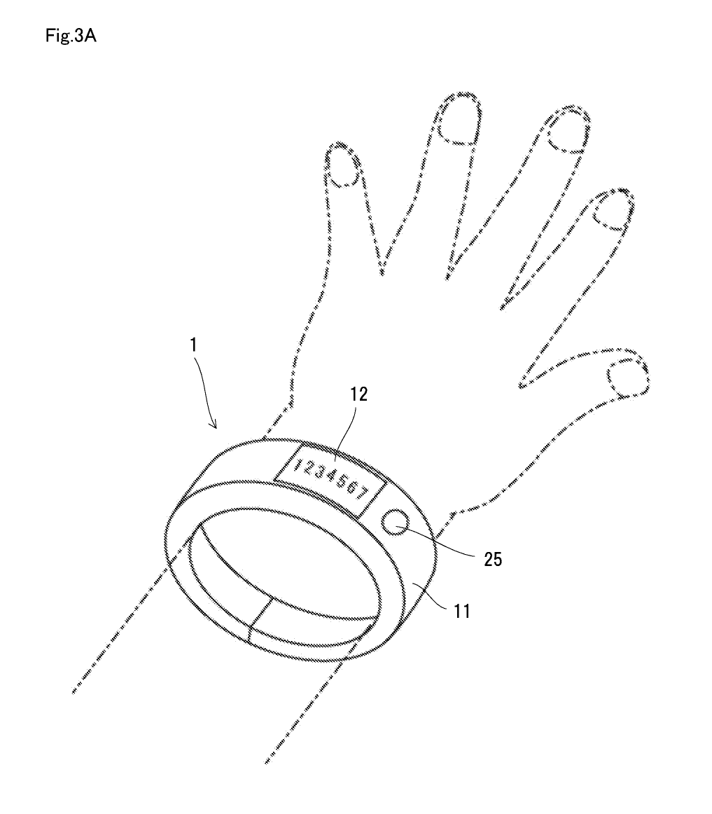

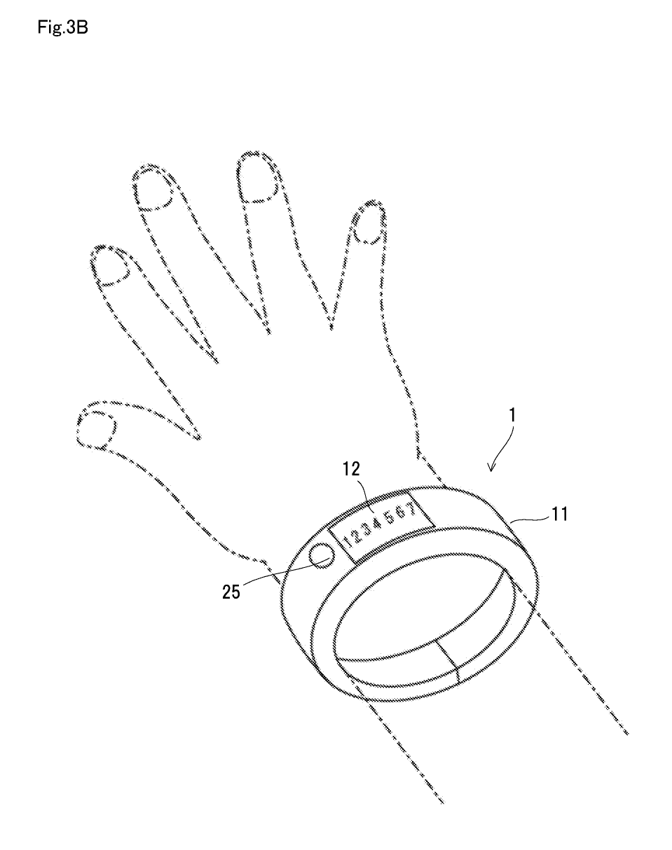

FIG. 3A shows a state where the arm-worn display device 1 is worn on the left arm. FIG. 3B shows a state where the arm-worn display device 1 is worn on the right arm. As shown in FIGS. 3A and 3B, when the arm-worn display device 1 is worn on the left arm, one side of the band unit 11 in the width direction is positioned closer to the wrist. When the arm-worn display device 1 is worn on the right arm, the other side of the band unit 11 in the width direction is positioned closer to the wrist. In other words, the orientation of the band unit 11 in the width direction when the arm-worn display device 1 is worn on the left arm is opposite to that when worn on the right arm, relative to the arm.

Even in the case that the arm-worn display device 1 is thus worn, in one of the opposite directions along the width direction of the band unit 11, depending on whether the arm-worn display device 1 is worn on the left arm or the right arm, the upward/downward direction of the display unit 12 is detected at the time when the arm-worn display device 1 is attached to an arm, and on the basis of the detection result, the display orientation of the display unit 12 is set such that the downward direction of character information, etc., displayed on the display unit 12 coincides with the downward direction of the display unit 12.

As a result, even when a user switches the arm-worn display device 1 between the left arm and the right arm, the user can easily visually recognize character information, etc., displayed on the display unit 12 of the arm-worn display device 1.

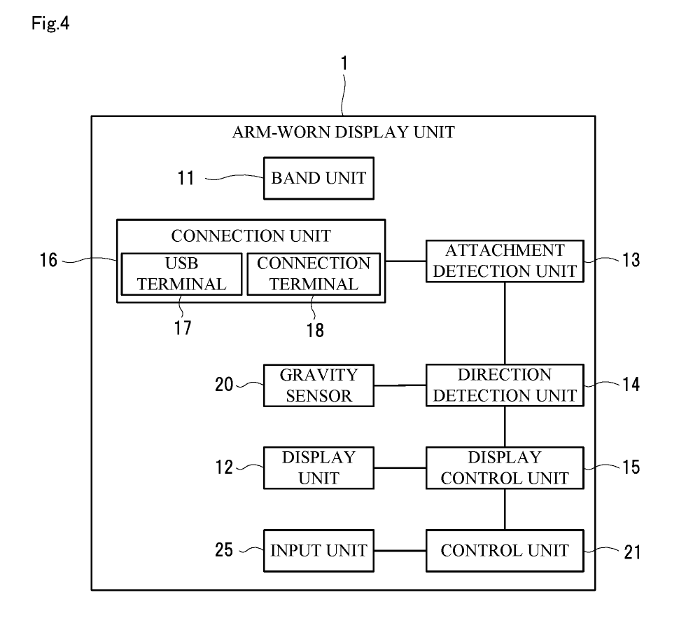

Next, a more specific configuration of the arm-worn display device 1 will be described in detail with reference to FIGS. 2 and 4.

As described above, the arm-worn display device 1 includes the band unit 11, the display unit 12, the attachment detection unit 13, the direction detection unit 14, and the display control unit 15. The arm-worn display device 1 also includes a connection unit 16, a gravity sensor 20, a control unit 21, and an input unit 25.

The band unit 11, which is formed in the shape of a band, is provided with the connection unit 16 at the end portions 11a and 11b in the longitudinal direction. The band unit 11 is in the shape of a circular ring when the end portions 11a and 11b in the longitudinal direction are connected together through the connection unit 16. Therefore, the arm-worn display device 1 can be attached to an arm by connecting the end portions 11a and 11b together with the band unit 11 being wrapped around the arm.

As shown in FIG. 2, the connection unit 16 has a protruding portion 16a that is provided in the end portion 11a of the band unit 11, and a recessed portion 16b provided in the end portion 11b of the band unit 11.

The protruding portion 16a protrudes in the longitudinal direction from an end surface of the end portion 11a of the band unit 11. The recessed portion 16b is formed in an end surface of the end portion 11b. The protruding portion 16a is configured such that the protruding portion 16a can be connected to the recessed portion 16b. Specifically, the protruding portion 16a is configured such that the protruding portion 16a can be inserted into the recessed portion 16b, and at least a portion of the protruding portion 16a is made contact with an internal surface of the recessed portion 16b so that the protruding portion 16a is connected to the recessed portion 16b. The protruding portion 16a is also configured such that the protruding portion 16a can be detached from the recessed portion 16b. Note that the protruding portion 16a and the recessed portion 16b may have any configuration that allows the protruding portion 16a and the recessed portion 16b to be detachably connected to each other.

The protruding portion 16a is provided with a USB terminal 17. Meanwhile, the recessed portion 16b is provided with a connection terminal 18 that is electrically connected to the USB terminal 17 of the protruding portion 16a when the protruding portion 16a is inserted in the recessed portion 16b. As a result, when the protruding portion 16a is inserted in the recessed portion 16b, the USB terminal 17 of the protruding portion 16a is connected to the connection terminal 18 of the recessed portion 16b, so that a conduction state is established. The USB terminal 17 and the connection terminal 18 are each electrically coupled to the attachment detection unit 13. Therefore, when the USB terminal 17 and the connection terminal 18 are in the conduction state, the connection between the USB terminal 17 and the connection terminal 18 is electrically detected by the attachment detection unit 13.

The USB terminal 17 is configured such that the USB terminal 17 can be connected to a USB port of a computer, etc. Therefore, by connecting the USB terminal 17 to a USB port of a computer, etc., charging and data exchange, etc., can be performed between the arm-worn display device 1 and the computer, etc.

The attachment detection unit 13 detects the conduction state between the USB terminal 17 and the connection terminal 18 in the connection unit 16. Specifically, the attachment detection unit 13 is configured to output a verification signal to one of the USB terminal 17 and the connection terminal 18, and is also configured to detect the verification signal which has been transmitted through the USB terminal 17 and the connection terminal 18 when the USB terminal 17 and the connection terminal 18 is in the conduction state.

The attachment detection unit 13 is configured to output the verification signal at regular intervals. This configuration allows the attachment detection unit 13 to regularly check whether or not the USB terminal 17 and the connection terminal 18 are connected together.

The attachment detection unit 13 is not limited to the above configuration. The attachment detection unit 13 may have any configuration that allows for detection of connection between the protruding portion 16a and the recessed portion 16b. For example, the attachment detection unit may have a switch or sensor for detecting connection between the protruding portion 16a and the recessed portion 16b, and detect an output of the switch or sensor.

When the attachment detection unit 13 has detected connection between the USB terminal 17 and the connection terminal 18, i.e., when the attachment detection unit 13 has detected the attachment of the band unit 11 to an arm, the attachment detection unit 13 outputs an attachment detection signal.

Note that the attachment detection unit 13 may have a sensor that detects that the distance between the sensor and the skin is not more than a predetermined value, and thereby detect that the band unit 11 has been attached to an arm. In other words, the attachment detection unit 13 may have any configuration that can detect that the band unit 11 has been attached to an arm.

When the attachment detection unit 13 has output the attachment detection signal, i.e., when the attachment detection unit 13 has detected the attachment of the band unit 11 to an arm, the direction detection unit 14 detects the upward/downward direction of the display unit 12 using the gravity sensor 20. Specifically, when the attachment detection unit 13 has output the attachment detection signal, the direction detection unit 14 reads a signal output from the gravity sensor 20 to determine the upward/downward direction of the display unit 12.

When the direction detection unit 14 has detected the upward/downward direction of the display unit 12, the direction detection unit 14 outputs a signal related to at least one of the downward direction and the upward direction of the display unit 12, as a direction detection signal.

The gravity sensor 20 is configured to output a signal related to the upward/downward direction of the display unit 12. The gravity sensor 20 includes, for example, a sensor that can detect a direction, such as an acceleration sensor, a gyroscopic sensor, etc. The signal output by the gravity sensor 20 is input to the direction detection unit 14.

Note that the gravity sensor 20 may have any configuration that can detect the upward/downward direction of the display unit 12.

The display control unit 15 controls displaying on the display unit 12. Specifically, the display control unit 15 displays information, etc., on the display unit 12 on the basis of a signal related to the information, etc., that is output from the control unit 21 described below.

The display control unit 15 also controls the display orientation of information, etc., displayed on the display unit 12, on the basis of the direction detection signal output from the direction detection unit 14. Specifically, when the direction detection unit 14 has output the direction detection signal, the display control unit 15 sets the display orientation of the display unit 12 such that the display orientation of information, etc., displayed on the display unit 12 is suited to a direction contained in the direction detection signal. For example, when the direction detection signal contains information indicating the downward direction of the display unit 12, the display control unit 15 sets the display orientation of the display unit 12 such that the downward direction of the display orientation of information, etc., displayed on the display unit 12 coincides with the information indicating the downward direction.

After having set the display orientation of information, etc., on the display unit 12, the display control unit 15 fixes the display orientation. Specifically, after the display control unit 15 has set the display orientation of the display unit 12 on the basis of the output of the direction detection signal from the direction detection unit 14, the display orientation of the display unit 12 is kept unchanged, irrespective of changes in the upward/downward direction of the display unit 12.

The display unit 12 is provided on the outer peripheral surface and in a middle portion in the longitudinal direction of the band unit 11 that is in the shape of a circular ring when worn on an arm. The display unit 12 includes, for example, a liquid crystal display device, an LED display device including a plurality of LEDs, etc. The display unit 12 displays information including character information in such a manner that the upward/downward direction of the information coincides with the width direction of the band unit 11 and the information is aligned in the longitudinal direction of the band unit 11.

The display unit 12 displays information, etc., on the basis of a signal, such as information output from the control unit 21 described below. The displaying of information, etc., by the display unit 12 is controlled by the display control unit 15. Specifically, at the time when the band unit 11 is attached to an arm, the display orientation of the display unit 12 is set by the display control unit 15 such that the upward/downward direction of the display orientation of information, etc., coincides with the upward/downward direction of the display unit 12.

The control unit 21 obtains and outputs a display content (information, etc.) that is to be displayed on the display unit 12. For example, in order to display the amount of activity of a user, etc., on the display unit 12, the control unit 21 calculates the amount of activity, etc., and outputs a signal indicating the calculation result to the display unit 12. The control unit 21 also changes various settings of the arm-worn display device 1 in accordance with inputs to the input unit 25 described below, and outputs a signal for changing displaying on the display unit 12 to the display control unit 15.

The input unit 25 is provided in the band unit 11, next to the display unit 12 in the longitudinal direction of the band unit 11. The input unit 25 is, for example, a switch that, when pressed, outputs a signal. The signal output from the input unit 25 is input to the control unit 21. By pressing and operating the input unit 25, various settings of the arm-worn display device 1 can be changed, and displaying on the display unit 12 can be changed, etc.

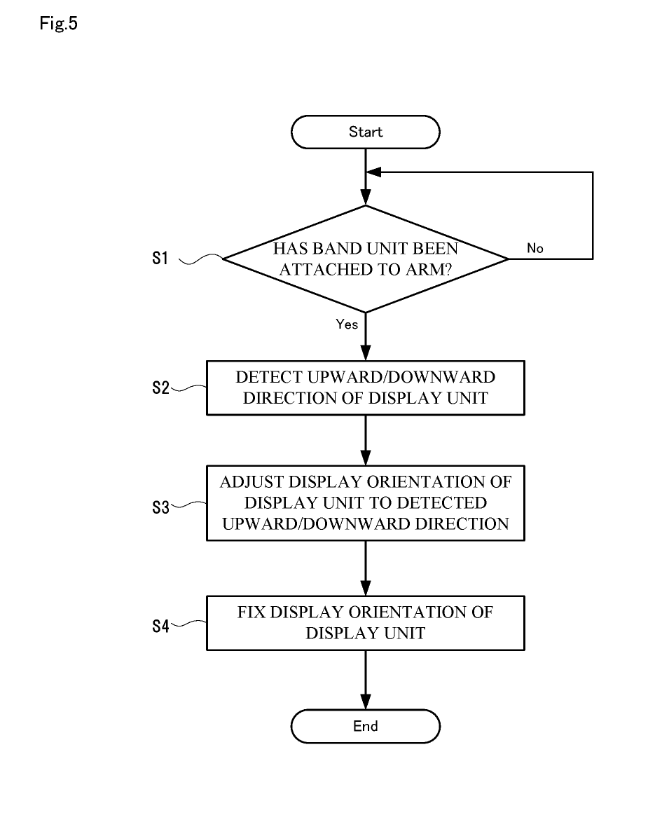

Next, an operation of the arm-worn display device 1 according to the embodiment of the present invention will be described with reference to FIG. 5. FIG. 5 is a flowchart showing display control of the arm-worn display device 1. In the description that follows, FIG. 3A, FIG. 3B, and FIG. 4 are referred to as appropriate. In this embodiment, a display method is carried out by the arm-worn display device 1 being operated. Therefore, the description of the operation of the arm-worn display device 1 applies to the display method of this embodiment.

At the start (Start) of the flow of FIG. 5, initially, the arm-worn display device 1 determines whether or not the band unit 11 has been attached to an arm (step S1). The determination is performed on the basis of whether or not the attachment detection unit 13 has detected the connection of the connection unit 16, i.e., the connection between the USB terminal 17 and the connection terminal 18.

If, in step S1, it is determined that the band unit 11 has been attached to an arm (YES), i.e., the attachment detection signal has been output from the attachment detection unit 13, control proceeds to step S2, in which the direction detection unit 14 detects the upward/downward direction of the display unit 12. To do so, the direction detection unit 14 reads a signal output from the gravity sensor 20 on the basis of the attachment detection signal output from the attachment detection unit 13. The direction detection unit 14 detects the upward/downward direction of the display unit 12 from the read signal. The direction detection unit 14 detects at least one of the upward direction and the downward direction of the display unit 12.

Meanwhile, if, in step S1, it is determined that the connection unit 16 is not connected (NO), i.e., the attachment detection signal has not been output from the attachment detection unit 13, the determination of step S1 is repeatedly performed until the connection unit 16 is connected.

In step S3 following step S2, the display control unit 15 sets the display orientation of the display unit 12 such that the display orientation of the display unit 12 is suited to the upward/downward direction of the display unit 12 detected by the direction detection unit 14. For example, when the direction detection unit 14 has detected the downward direction of the display unit 12, the display control unit 15 sets displaying on the display unit 12 such that the downward direction of the display orientation of the display unit 12 coincides with the downward direction of the display unit 12.

In step S4, the display control unit 15 fixes the display orientation of the display unit 12. As a result, thereafter, the display orientation of the display unit 12 is kept fixed as long as the display orientation of the display unit 12 is not changed in accordance with the flow of FIG. 5.

Thereafter, the flow is ended (End).

Here, step S1 of detecting attachment of the band unit 11 to an arm corresponds to an attachment detection step. Step S2 of detecting at least one of the upward direction and the downward direction of the display unit 12 when step S1 has detected the attachment of the band unit 11 to an arm corresponds to a direction detection step. Step S3 of setting the display orientation of the display unit 12 on the basis of the detection result obtained in the direction detection step corresponds to a display setting step.

According to the configuration of this embodiment, at the time when the arm-worn display device 1 is attached to an arm, the display orientation of information, etc., displayed on the display unit 12 can be set on the basis of the upward/downward direction of the display unit 12. As a result, even when the arm-worn display device 1 is switched between the left and right arms, information, etc., is displayed on the display unit 12 in a display orientation that is suited to the upward/downward direction of the display unit 12. Therefore, when the arm-worn display device 1 is switched between the left and right arms, information, etc., can be prevented from being displayed upside down on the display unit 12. Therefore, the visibility of the arm-worn display device 1 can be improved.

A program according to an embodiment of the present invention may be any program that causes a computer to execute steps S1 to S4 of FIG. 5. By installing and executing the program in a computer, the arm-worn display device and display method of this embodiment can be implemented. In this case, a central processing unit (CPU) of the computer functions as the attachment detection unit 13, the direction detection unit 14, and the display control unit 15, and performs processing.

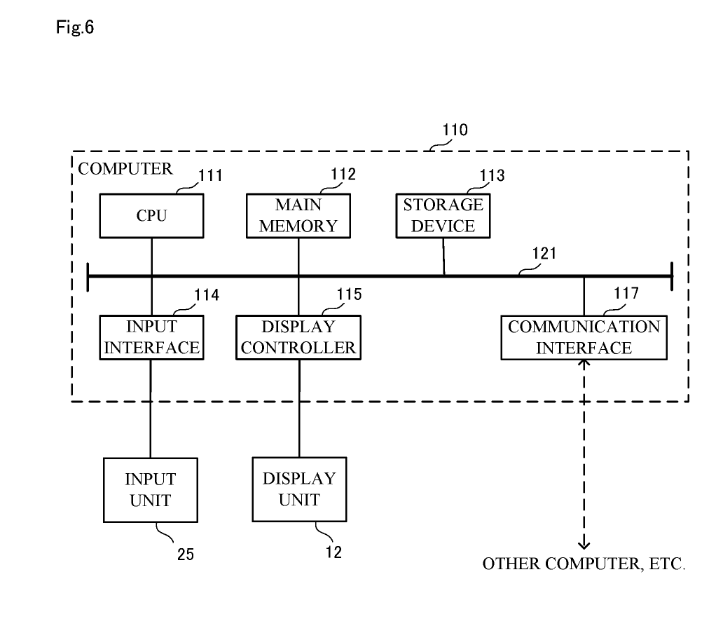

Here, a computer that executes the program of this embodiment to carry out the display control of the arm-worn display device will be described with reference to FIG. 6. FIG. 6 is a block diagram showing an example computer that carries out the display control of the arm-worn display device according to the embodiment of the present invention.

As shown in FIG. 6, a computer 110 includes a CPU 111, a main memory 112, a storage device 113, an input interface 114, a display controller 115, and a communication interface 117. These units are coupled together through a bus 121 so that the units can exchange data with each other.

The CPU 111 downloads programs (codes) according to this embodiment stored in the storage device 113 into the main memory 112, executes the programs in a predetermined order, and thereby carries out various computations. The main memory 112 is typically a volatile storage device, such as a dynamic random access memory (DRAM), etc. Note that the programs of this embodiment may be available from the Internet, which is connected through the communication interface 117.

A specific example of the storage device 113 is a semiconductor storage device, such as a flash memory, etc. The input interface 114 mediates data transfer between the CPU 111, and the input unit 25, such as an input button. The display controller 115, which is connected to the display unit 12, controls displaying on the display unit 12.

The communication interface 117 mediates data transfer between the CPU 111 and another computer.

All or a portion of the above embodiment can be implemented by (Supplementary Note 1) to (Supplementary Note 10) described below, and are not limited to the following descriptions.

(Supplementary Note 1)

An arm-worn display device comprising:

a band unit configured to be worn on an arm;

a display unit configured to display character information in such a manner that an upward/downward direction of the character information coincides with a width direction of the band unit and the character information is aligned in a longitudinal direction of the band unit;

an attachment detection unit configured to detect attachment of the band unit to an arm;

a direction detection unit configured to detect at least one of an upward direction and a downward direction of the display unit when the attachment detection unit has detected the attachment of the band unit to an arm; and

a display control unit configured to set a display orientation of the display unit on the basis of a detection result of the direction detection unit.

(Supplementary Note 2)

The arm-worn display device according to Supplementary Note 1, wherein the display control unit sets the display orientation of the display unit such that a direction detected as the downward direction of the display unit by the direction detection unit coincides with the downward direction of the character information.

(Supplementary Note 3)

The arm-worn display device according to Supplementary Note 1 or 2, wherein after determining the display orientation of the display unit, the display control unit fixes the display orientation of the display unit.

(Supplementary Note 4)

The arm-worn display device according to any one of Supplementary Notes 1 to 3, further including a connection unit provided in an end portion of the band unit, and configured to connect the band unit into a circular-ring shape so that the band unit is allowed to be worn on an arm,

wherein

the attachment detection unit detects the attachment of the band unit to an arm, on the basis of the connection of the connection unit.

(Supplementary Note 5)

A displaying method for an arm-worn display device including:

a band unit configured to be worn on an arm, and

a display unit configured to display character information in such a manner that an upward/downward direction of the character information coincides with a width direction of the band unit and the character information is aligned in a longitudinal direction of the band unit,

the method comprising:
an attachment detection step of detecting attachment of the band unit to an arm;
a direction detection step of detecting at least one of an upward direction and a downward direction of the display unit when the attachment of the band unit to an arm is detected in the attachment detection step; and
a display setting step of setting a display orientation of the display unit on the basis of a detection result of the direction detection step.

(Supplementary Note 6)

The displaying method according to Supplementary Note 5, wherein the display setting step sets the display orientation of the display unit such that a direction detected as the downward direction of the display unit in the direction detection step coincides with the downward direction of the character information.

(Supplementary Note 7)

The displaying method according to Supplementary Note 5 or 6, wherein the arm-worn display device further includes a connection unit provided in an end portion of the band unit, and configured to connect the band unit into a circular-ring shape so that the band unit is allowed to be worn on an arm, and

the attachment detection step detects the attachment of the band unit to an arm, on the basis of the connection of the connection unit.

(Supplementary Note 8)

A computer-readable recording medium storing a program for controlling displaying on an arm-worn display device including

a band unit configured to be worn on an arm,

a display unit configured to display character information in such a manner that an upward/downward direction of the character information coincides with a width direction of the band unit and the character information is aligned in a longitudinal direction of the band unit, and

a computer,

the medium comprising instructions for causing the computer to execute:
an attachment detection step of detecting attachment of the band unit to an arm;
a direction detection step of detecting at least one of an upward direction and a downward direction of the display unit when the attachment detection unit has detected the attachment of the band unit to an arm; and

a display setting step of setting a display orientation of the display unit on the basis of a detection result of the direction detection step.

(Supplementary Note 9)

The computer-readable recording medium according to Supplementary Note 8, wherein the display setting step sets the display orientation of the display unit such that a direction detected as the downward direction of the display unit in the direction detection step coincides with the downward direction of the character information.

(Supplementary Note 10)

The computer-readable recording medium according to Supplementary Note 8 or 9, wherein the arm-worn display device further includes a connection unit provided in an end portion of the band unit, and configured to connect the band unit into a circular-ring shape so that the band unit is allowed to be worn on an arm, and

the attachment detection step detects the attachment of the band unit to an arm, on the basis of the connection of the connection unit.

In the foregoing, the invention of the present application has been described with reference to the embodiments. The invention of the present application is in no way limited to the above embodiments. Various changes that would be understood by those skilled in the art can be made to the embodiments and implementations of the invention of the present application without departing the scope of the invention of the present application.

This application claims priority to Japanese Patent Application No. 2015-186385, filed on Sep. 24, 2015, the entire disclosure of which is incorporated by reference herein.

### INDUSTRIAL APPLICABILITY

The present invention is applicable to arm-worn display devices that display character information in such a manner that an upward/downward direction of the character information coincides with a width direction of a band unit, and the character information is aligned in a longitudinal direction of the band unit.

### REFERENCE SIGNS LIST

1 arm-worn display device
11 band unit
11a end portion
11b end portion
12 display unit
13 attachment detection unit
14 direction detection unit
15 display control unit
16 connection unit
16a protruding portion
16b recessed portion
17 USB terminal
18 connection terminal
20 gravity sensor
21 control unit
25 input unit

1. An arm-worn display device comprising:
a band unit configured to be worn on an arm;
a display unit configured to display character information in such a manner that an upward/downward direction of the character information coincides with a width direction of the band unit and the character information is aligned in a longitudinal direction of the band unit;
an attachment detection unit configured to detect attachment of the band unit to an arm;
a direction detection unit configured to detect at least one of an upward direction and a downward direction of the display unit when the attachment detection unit has detected the attachment of the band unit to an arm; and
a display control unit configured to set a display orientation of the display unit on the basis of a detection result of the direction detection unit.

2. The arm-worn display device according to claim 1, wherein the display control unit sets the display orientation of the display unit such that a direction detected as the downward direction of the display unit by the direction detection unit coincides with the downward direction of the character information.

3. The arm-worn display device according to claim 1, wherein after determining the display orientation of the display unit, the display control unit fixes the display orientation of the display unit.

4. The arm-worn display device according to claim 1, further comprising a connection unit provided in an end portion of the band unit, and configured to connect the band unit into a circular-ring shape so that the band unit is allowed to be worn on an arm,
wherein the attachment detection unit detects the attachment of the band unit to an arm, on the basis of the connection of the connection unit.

5. A displaying method for an arm-worn display device including:
a band unit configured to be worn on an arm, and
a display unit configured to display character information in such a manner that an upward/downward direction of the character information coincides with a width direction of the band unit and the character information is aligned in a longitudinal direction of the band unit,
the method comprising:
an attachment detection step of detecting attachment of the band unit to an arm;
a direction detection step of detecting at least one of an upward direction and a downward direction of the display unit when the attachment of the band unit to an arm is detected in the attachment detection step; and
a display setting step of setting a display orientation of the display unit on the basis of a detection result of the direction detection step.

6. The displaying method according to claim 5,
wherein the display setting step sets the display orientation of the display unit such that a direction detected as the downward direction of the display unit in the direction detection step coincides with the downward direction of the character information.

7. The displaying method according to claim 5,
wherein the arm-worn display device further includes a connection unit provided in an end portion of the band unit, and configured to connect the band unit into a circular-ring shape so that the band unit is allowed to be worn on an arm, and
the attachment detection step detects the attachment of the band unit to an arm, on the basis of the connection of the connection unit.

8. A non-transitory computer-readable recording medium storing a program for controlling displaying on an arm-worn display device including
a band unit configured to be worn on an arm,
a display unit configured to display character information in such a manner that an upward/downward direction of the character information coincides with a width direction of the band unit and the character information is aligned in a longitudinal direction of the band unit, and
a computer,
the medium comprising instructions for causing the computer to execute:
an attachment detection step of detecting attachment of the band unit to an arm;
a direction detection step of detecting at least one of an upward direction and a downward direction of the display unit when the attachment of the band unit to an arm is detected in the attachment detection step; and
a display setting step of setting a display orientation of the display unit on the basis of a detection result of the direction detection step.

9. The non-transitory computer-readable recording medium according to claim 8,
wherein the display setting step sets the display orientation of the display unit such that a direction detected as the downward direction of the display unit in the direction detection step coincides with the downward direction of the character information.

10. The non-transitory computer-readable recording medium according to claim 8,
wherein the arm-worn display device further includes a connection unit provided in an end portion of the band unit, and configured to connect the band unit into a circular-ring shape so that the band unit is allowed to be worn on an arm, and
the attachment detection step detects the attachment of the band unit to an arm, on the basis of the connection of the connection unit.
